(19) United States
(12) Patent Application Publication
(10) Pub. No.: US 2010/0029276 A1
(43) Pub. Date: Feb. 4, 2010

(54) METHOD AND APPARATUS FOR PERFORMING HANDOVER IN WIRELESS TELECOMMUNICATION SYSTEM

(75) Inventor: Sang-Roc Hwang, Anyang-si (KR)

Correspondence Address: AMPACC Law Group, 3500 188th Street S.W., SUITE 103, Lynnwood, WA, 98037, US

(73) Assignee: Posdata Co., Ltd., Seongnam-si (KR)

(21) Appl. No.: 12/443,168

(22) PCT Filed: Sep. 19, 2007
(86) PCT No.: PCT/KR07/04538

§ 371 Date: Mar. 26, 2009

(30) Foreign Application Priority Data
Oct. 2, 2006 (KR) 10-2006-0097168

(51) Int. Cl. H04W 36/00

(52) U.S. Cl. 455/436

(57) ABSTRACT

The present invention relates to a method and apparatus for performing a handover in a wireless telecommunication system. The present invention measures a signal strength of a serving base station and a neighbor base station, and triggers an anchor base station update when the signal strength of the neighbor base station is higher than the signal strength of the serving base station by a predetermined triggering value, thereby preventing the signal strength of the serving base station from being rapidly decreased and capable of efficiently performing a handover.

### TECHNICAL FIELD

The present invention relates, in general, to a method and apparatus for performing a handover in a wireless telecommunication system, and, more particularly, to a method and apparatus for performing a handover in a wireless telecommunication system, in which an anchor base station update is efficiently triggered using a Medium Access Control (MAC) management message or a Fast Feedback Channel (FFC) while a terminal maintains Diversity Set of Fast Base Station Switching (FBSS) in a wireless telecommunication system based on IEEE 802.16 standard.

### BACKGROUND ART

One of wireless telecommunication systems based on IEEE 802.16e is Wireless Broadband (Wibro) and Wimax which is a portable internet system. The Wibro and Wimax adopts Orthogonal Frequency Division Multiplexing (OFDM) using orthogonal frequencies as signal transmitting method, Orthogonal Frequency Division Multiple Access (OFDMA) as multiple access method, and Time Division Duplexing (TDD) as duplexing method, being capable of high-speed data services even when a user is moving in a wireless environment.

Meanwhile, when a terminal such as Mobile Station (MS) or Portable Subscriber Station (PSS) moves away from Base Station (BS) or Radio Access Station (RAS), the strength of signals decreases, so that Quality of Service (QoS) is reduced. In order to prevent this, when the signal strength of a currently serving base station (hereinafter, ‘serving BS’) is decreased below a predetermined level, the wireless link is switched to a new base station (hereinafter, ‘target BS’), thereby performing handover.

FIG. 1 is a diagram illustrating the method of performing handover according to a related art.

In FIG. 1, a ‘diversity set addition threshold value (H_Add_Threshold)’ represents a predetermined threshold value used to add a neighbor base station to a diversity set, whereas a ‘diversity set deletion threshold value (H_Delete_Threshold)’ represents a predetermined threshold value used to delete a serving base station or a neighbor base station from the diversity set. In this case, the ‘diversity set’ means a set of base stations which are activated for terminals, which is managed by the terminal and the base station.

Referring to FIG. 1, it is exemplified that the signal strength of a serving base station is decreased and the signal strength of a neighbor base station is increased as the terminal moves. When the signal strength of a second base station which is a neighbor base station is equal to or higher than (or exceeds) the diversity set addition threshold value at time t as the terminal moves, the diversity set update is occurred, and thereby, the second base station is added to the diversity set. Thereafter, when the signal strength of a first base station which is a serving base station is equal to or lower than (or below) the diversity set deletion threshold value at time t as the terminal continuously moves, the terminal requests the base station to perform anchor BS update, and thus, the handover to one (the second base station in FIG. 1) of base stations which is included in the diversity set is performed. For reference, the solid line of FIG. 1 indicates the state of the serving base station, that is, the anchor base station, while the dot line indicates the state of the neighbor base station.

However, the method of performing handover according to the related art has a problem in that the terminal or the base station can not estimate the time point of the anchor base station update until the signal strength measured by the terminal with respect to the current serving base station (anchor base station) is equal to or lower than the diversity set deletion threshold value.

Additionally, the anchor base station must perform a preparatory work for handover through a network communication with other base stations when a request for the anchor base station update is received between the terminal and the base station. In case the signal strength is rapidly decreased, the connection between the terminal and the anchor base station may be cut off even before the preparatory work is completed.

Furthermore, the object for FBSS (Fast BS Switching) is to minimize the handover operation between base stations, however, an unnecessary network re-establishment can be caused due to such problem.

### DISCLOSURE OF INVENTION

### Technical Problem

Accordingly, the present invention has been made in view of the above problems occurring in the related art, and it is an object of the present invention to provide a method and apparatus for performing handover in a wireless telecommunication system, in which it is capable of triggering the anchor base station update in case the difference between the signal strength of an anchor base station and the signal strength of a neighbor base station is a predetermined level (the triggering value) or more when the signal strength of the anchor base station is compared to the signal strength of the neighbor base station, even before the signal strength of the anchor base station decreases below a diversity set deletion threshold value.

Additionally, another object of the present invention is to provided a method and apparatus for performing handover in a wireless telecommunication system which efficiently triggers the anchor base station update using a MAC management message and a Fast Feedback Channel (FFC) while the diversity set of FBSS is maintained.

A further object of the present invention is to provide a method and apparatus for performing handover in a wireless telecommunication system which rapidly selects an anchor base station in order to cope with the rapid decrease of the signal strength of the anchor base station.

Still further object of the present invention is to provide a method and apparatus for performing handover in a wireless telecommunication system which efficiently triggers the anchor base station update by additionally defining a trigger TLV in a Downlink Channel Descriptor (DCD) message among MAC management messages defined in IEEE 802.16d/e.

### Technical Solution

According to an aspect of the present invention, there is provided a method of performing handover in a wireless communication system, which comprises the steps of a) receiving a Downlink Channel Descriptor (DCD) message from a serving base station and acquiring Fast Base Station Switching (FBSS) information; b) receiving a neighbor base station advertisement message from the serving base station and acquiring neighbor base station information; c) measuring the signal strengths of the serving base station and the neighbor base station based on the neighbor base station information; d) transmitting a handover request message to the serving base station when the difference between the signal strength of the neighbor base station and the signal strength of the serving base station has a predetermined triggering value; and e) transmitting a handover indication message to the serving base station and performing handover by triggering anchor base station update when a handover response message is received from the serving base station in response to the handover request message.

According to another aspect of the present invention, there is provided a method of performing handover in a wireless communication system, the method comprising the steps of: a) receiving a Downlink Channel Descriptor (DCD) message and a neighbor base station advertisement message from a serving base station and acquiring a signal strength of the serving base station and a neighbor base station; b) transmitting an anchor switching indication message to the serving base station through a fast feedback channel, when the signal strength of the neighbor base station is higher than the signal strength of the serving base station as much as a predetermined triggering value; and c) performing a handover by triggering the anchor base station update when an anchor switching information message for permitting the anchor switching in response to the anchor switching indication message is received from the serving base station.

According to another aspect of the present invention, there is provided a method of performing handover in a wireless communication system, the method comprising the steps of: a) measuring signal strengths of a serving base station and a neighbor base station; and b) performing a handover when the signal strength of the neighbor base station is higher than the signal strength of the serving base station as much as a predetermined triggering value.

According to an aspect of the present invention, there is provided an apparatus of performing handover in a wireless communication system, the apparatus comprising: a signal strength measuring unit for measuring a signal strength for a serving base station and a neighbor base station; a MAC management message processing unit for transmitting and receiving a MAC management message for the serving base station; an anchor base station update processing unit for triggering an anchor base station update; and a FBSS processing unit for requesting the anchor base station update processing unit to trigger the anchor base station update, when the signal strength of the neighbor base station is higher than the signal strength of the serving base station by a predetermined triggering value, based on a DCD message transmitted from the MAC management message processing unit.

### Advantageous Effects

According to the present invention, the rapid decrease of the signal strength of an anchor base station is prevented by triggering an anchor base station update in case the difference between the signal strength of the anchor base station and the signal strength of a neighbor base station is equal to or higher than a predetermined level when the signal strength of the anchor base station is compared with the signal strength of the neighbor base station, thereby it is capable of providing the high quality of communication services.

Furthermore, the present invention efficiently performs handover using a MAC management message or a fast feedback channel (FFC) while the diversity set of FBSS is maintained.

Furthermore, the present invention can efficiently perform handover by efficiently triggering the anchor base station update using an IEEE 802.16d/e based DCD message.

### BRIEF DESCRIPTION OF THE DRAWINGS

FIG. 1 is a diagram illustrating a method of performing a handover of a related art;

FIG. 2 is a diagram illustrating a method of performing a handover according to the present invention;

FIG. 3 is a diagram illustration the structure of a DCD message according to the present invention;

FIG. 4 is a flowchart illustrating the method of performing a handover according to a first embodiment of the present invention;

FIG. 5 is a flowchart illustrating the method of performing a handover according to a second embodiment of the present invention; and

FIG. 6 is a configuration diagram illustrating an apparatus for performing a handover according to the present invention.

### MODE FOR THE INVENTION

Hereinafter, an exemplary embodiment of the present invention will be described in detail with reference to the accompanying drawings. Well known functions and constructions are not described in detail since they would obscure the invention in unnecessary detail.

FIG. 2 is a diagram illustrating a method of performing a handover according to the present invention.

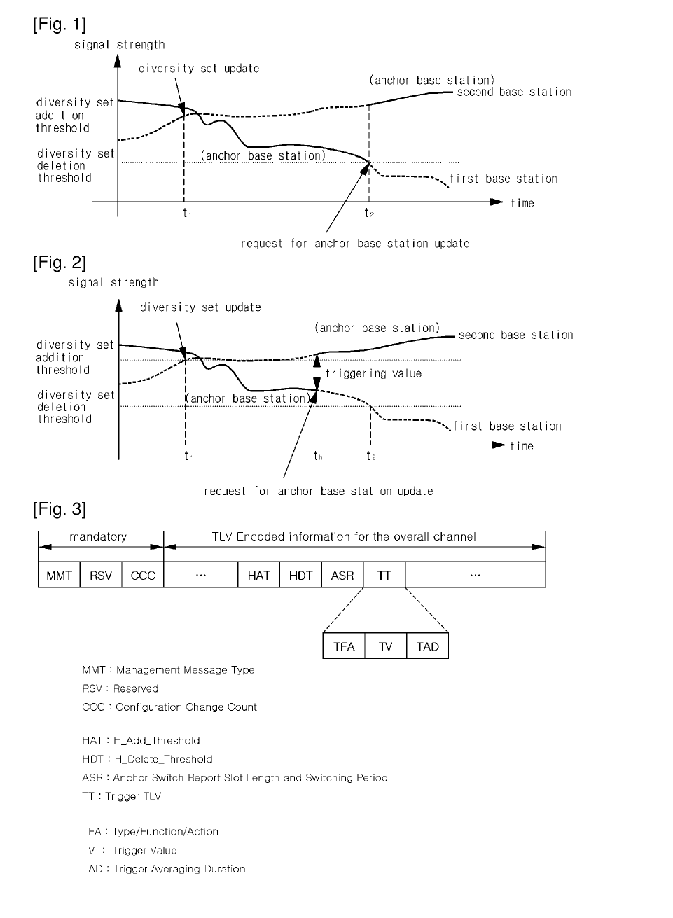

In comparison with the related art of FIG. 1, the present invention performs handover by triggering the anchor base station update when the difference between the signal strength of a serving base station and the signal strength of a neighbor base station is equal to or higher than a predetermined level (the triggering value) even before the signal strength of the serving base station decreases below a diversity set deletion threshold value.

Referring to FIG. 2, when a terminal moves from a base station which is a serving base station (anchor base station) to a second base station which is a neighbor base station, so that the signal strength of the second base station is equal to or higher than (or exceeds) the diversity set addition threshold value at time t, the diversity set update is occurred, thereby causing the second base station to be added to the diversity set. Thereafter, when the terminal continuously moves and the signal strength of the second base station is higher than the signal strength of the first base station (serving base station) by the triggering value, the terminal requests the first base station to perform the anchor BS update, thereby performing handover. The triggering value means the difference between signal strengths of the neighbor base station and the serving base station as a condition for performing handover, which can be appropriately determined in consideration of the number of terminals in service and the signal quality or, preferably, is determined to be below the difference value between the diversity set addition threshold value and the diversity set deletion value.

Thereafter, when the terminal continuously moves and the signal strength of the first base station is equal to or lower than (or below) the diversity set deletion threshold value at time t₂, the diversity set update is occurred, so that the first base station is deleted from the diversity set.

Meanwhile, it is preferable that the above-described handover scheme be performed using a MAC management message or a fast feedback channel. The method and apparatus for performing handover according to the present invention are described with reference to FIGS. 3 to 6.

First, FIG. 3 is a diagram illustration the structure of a Downlink Channel Descriptor (DCD) message according to the present invention.

The DCD message is a kind of MAC management messages, and describes characteristics on the wireless physical layer of a downlink, which is transmitted from the base station in the form of broadcast. As illustrated in FIG. 3, the DCD message according to the present invention includes mandatory fields and a TLV Encoded information for the overall channel (TLV) field, and particularly, includes a trigger TLV for performing handover according to the present invention in the TVL field.

The DCD message according to the present invention supports IEEE 802.16d/e. The structure of the DCD message according to the present invention is described below in detail with reference to FIG. 3 and Tables 1 to 5.

Table 1 represents the format of the DCD message according to an embodiment of the present invention.

TABLE 1

| | | |
|---|---|---|
| Syntax | Size | Notes |

DCD_Message_Format( ) {

| Management Message Type = 1 | 8 bits | |
|---|---|---|
| Reserved | 8 bits | Shall be set to zero |
| Configuration Change Count | 8 bits | |
| TLV Encoded information for the overall channel | Variable | TLV specific |

| | |
|---|---|
| Begin PHY Specific Section { | See applicable PHY subclause |

| | |
|---|---|
| for (i=1; i<=n; i+ + ) { | For each downlink burst |

| | profile 1 to n |
|---|---|
| Downlink_Burst_Profile | PHY specific |

}

}

}

Referring to Table 1, the DCD message corresponds to Type ‘1’ among MAC management messages, and includes a MAC Management Message Type (MMT) field and a Configuration Change Count (CCC) field as mandatory field, and also includes a TLV Encoded information for the overall channel (TLV) for FBSS. Type, Length and Value (TLV) encoding information for a downlink channel is included in the TLV filed.

As to the handover of the present invention, the DCD message includes ‘a diversity set addition threshold value (H_Add_Threshold)’ and ‘a diversity set deletion threshold value (H_Delete_Threshold) as illustrated in Table 2 in order to perform the management for the diversity set and the anchor base station update, and includes ‘Anchor Switch Report (ASR) Slot Length (M) and Switching Period (L)’ information in order to perform the anchor base station update rapidly using the fast feedback channel.

TABLE 2

| | | Length | Value |
|---|---|---|---|
| Name | Type | (byte) | (Variable length) |
| H Add Threshold | 31 | 1 | Threshold used by the MS to add a neighbor BS |
| | | | to the diversity set. When the CINR of a neighbor |
| | | | BS is higher than H_Add. The MS should send |
| | | | MOB_MSHO-REQ to request adding this |
| | | | neighbor BS to the diversity set. This threshold |
| | | | is used for the MS that is perform MDHO/FBSS |
| | | | HO. It is in the unit of dB. If the BS does not |
| | | | support FBSS HO/MDHO, this value is not set. |
| H Delete Threshold | 32 | 1 | Threshold used by the MS to drop a BS form the |
| | | | diversity set. When the CINR of a BS is lower |
| | | | than H_Delete, the MS should send MOB MSHO- |
| | | | REQ to request dropping this BS form the |
| | | | diversity set. This threshold is used for the MS |
| | | | that is performing MDHO/FBSS HO. It is in the |
| | | | unit of dB. If the BS dose not support FBSS |
| | | | HO/MDHO, this value is not set. |
| ASR(Anchor Switch | 33 | 1 | Bit #0-#3: M, in units of frames |
| Report) Slot Length (M) | | | Bit #4-#7: L, in units of ASR slots |
| and Switching Period (L) | | | |

Meanwhile, in the ‘Trigger TLV’ of the DCD message illustrated in Table 3, several trigger TLVs may be defined.

TABLE 3

| | | Length | Value |
|---|---|---|---|
| Name | Type | (byte) | (Variable length) |
| Trigger | 54 | Variable | The Trigger is a compound TLV value that |
| | | | indicates trigger metrics. The trigger in |
| | | | this encoding is defined for serving BS |
| | | | or commonly applied to neighbor BSs. |

Therefore, according to the present invention, when the signal strength of the neighbor base station is higher than the signal strength of the serving base station by the triggering value, the DCD message includes trigger TVLs as illustrated in Table 4 and 5 to trigger the anchor base station update. Furthermore, as signal strength, Carrier to Interference and Noise Ratio (CINR), Received Signal Strength Indication (RSSI) or Real Time Difference (RTD) is used as illustrated in Table 5.

TABLE 4

| | | Length | Value |
|---|---|---|---|
| Name | Type | (byte) | (Variable length) |
| Type/Function/Action | 54.1 | 1 | See Table 5 for description |
| Trigger value | 54.2 | 1 | Trigger value is the value used in comparing |
| | | | measured metric for determining a trigger |
| | | | condition |
| Trigger averaging | 54.3 | 1 | Trigger averaging duration is the time in MS |
| Duration | | | over which the metric measurements are |
| | | | averaged. When the mean value of the |
| | | | measurement meets the trigger condition, the MS |
| | | | reacts using the specified action. |

TABLE 5

| Name | Length | Notes | |
|---|---|---|---|
| Type | 2 bits | 0x0: | CINR |
| | | 0x1: | RSSI |
| | | 0x2: | RTD |
| Func- | 3 bits | Computation defining trigger condition: | |
| tion | | 0x0: | Reserved |
| | | 0x1: | Metric of neighbor BS is greater than absolute |
| | | | value |
| | | 0x2: | Metric of neighbor BS is less than absolute value |
| | | 0x3: | Metric of neighbor BS is greater than serving BS |
| | | | metric by relative value |
| | | 0x4: | Metric of neighbor BS is less than serving BS |
| | | | metric by relative value |
| | | 0x5: | Metric of serving BS greater than absolute value |
| | | 0x6: | Metric of serving BS less than absolute value |
| | | 0x7: | Reserved |
| | | NOTE- | |
| | | 0x1-0x4 not applicable for RTD trigger metric | |
| Ac- | 3 bits | Action performed upon reaching trigger condition: | |
| tion | | 0x0: | Reserved |
| | | 0x1: | Respond on trigger with MOB_SCN-REP after |
| | | | the end of each scanning interval |
| | | 0x2: | Respond on trigger with MOB_MSHO-REQ |
| | | 0x3: | On trigger, MS starts neighbor BS scanning |
| | | | process by sending MOB_SCN-REQ |
| | | 0x4: | Reserved |

NOTE-
0x3 is not applicable when neighbor BS metrics are
defined (i.e., only Function values 0x5-6 are applicable).

The contents defined in Table 4 and 5 is applied to the ‘Trigger TLV (TT)’ field of the DCD message illustrated in FIG. 3. For example, in case the value of the trigger TLV field is ‘00 011 010’, the terminal transmits a message (MOB_MSHO_REQ) requesting handover to the base station (Action 0x2) when the CINR of the neighbor base station is higher than the CINR of the serving base station by the triggering value (Function 0x3).

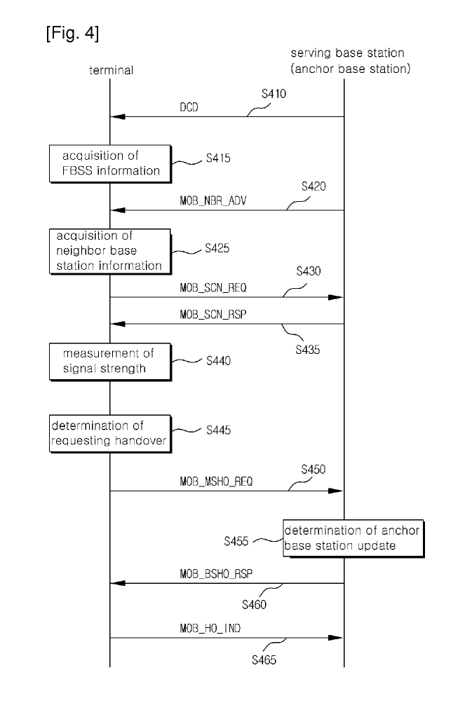

FIG. 4 is a flowchart illustrating the method of performing a handover according to a first embodiment of the present invention.

For reference, in this embodiment, the anchor base station update is performed using MAC management messages.

At step S410, the terminal receives the DCD message which is periodically transmitted from the serving base station (anchor base station). The DCD message includes information on ‘trigger TLV’ as well as information on ‘diversity set addition threshold (H_Add_Treshold)’, ‘diversity set deletion threshold (H_Delete_Treshold), ‘Anchor Switch Report (ASR) Slot Length (M) and Switching Period (L). Furthermore, at step S415, the terminal acquires FBSS information based on the DCD message.

Furthermore, the terminal receives a neighbor base station advertisement message (MOB_NBR_ADV) which is periodically transmitted by the serving base station at step S420. The neighbor base station advertisement message includes information on the channel parameters of the neighbor base station. Furthermore, the terminal acquires information on neighbor base stations based on the neighbor base station advertisement message at step S425.

At step S430, the terminal requests parameters required for scanning by transmitting a scanning request message (MOB_SCN_REQ) to the serving base station in order to measure the quality of signals received from the neighbor base station. Thereafter, the serving base station transmits a scanning response message (MOB_SCN_RSP) to the terminal at step S435. The scanning response message includes information on the scanning interval, the interleaving interval, the iteration, the start frame. Through the scanning response message, the terminal can know when the terminal can begin to measure the quality of signals of the neighbor base station and how long the terminal can perform the measurement.

At step S440, the terminal measures the signal quality by synchronizing with respective neighbor base stations and measuring the CINR during a predetermined scanning period. Furthermore, at step S445, the terminal determines the suitability of a base station for handover based on the measured signal quality, and determines whether a handover request is occurred or not. The determination of the suitability of a handover base station is performed using the diversity set addition threshold value (H_Add_Threshold) and the diversity set deletion threshold value (H_Delete_Threshold). For example, when the signal strength of the neighbor base station is higher than the diversity set addition threshold value, the neighbor base station is added into the diversity set, whereas, when the signal strength of the neighbor base station is lower than the diversity set deletion threshold value, the neighbor base station is deleted from the diversity set. Furthermore, the determination of the handover request is performed based on the condition that the signal strength of the serving base station decreases below the diversity set deletion threshold value. In addition, the present invention requests the handover even when the signal strength of the neighbor base station is higher than the signal strength of the serving base station by the triggering value. That is, the terminal requests the serving base station to perform the anchor base station update, when the condition for requesting handover (for example, the CINR of the serving base station is lower than the CINR of the neighbor base station by the triggering value) is satisfied, with reference to the ‘trigger TLV’ of the DCD message transmitted at step S410.

When the condition for requesting handover is satisfied at step S445, the terminal transmits a handover request message (MOB_MSHO_REQ) to the serving base station at step S450. At this time, the handover request message includes information on the signal strength of the serving base station and the neighbor base stations included in the diversity set.

At step S455, the serving base station (anchor base station) transmits information on the MAC address, the requested resource and the signal quality to the neighbor base station, and receives information on the supportable signal quality through the handover pre-notification message from the neighbor base station and determines the anchor base station update. In case the FBSS condition is satisfied and then the anchor base station update is determined, the serving base station transmits a handover response message (MOB_BSHO_RSP) to the terminal and a handover confirmation message (HO_Confirm) to a target base station at step S460. Thereafter, at step S465, the terminal cuts off a link with the serving base station through a handover indication message (MOB_HO_IND) and connects a link to the target base station, thereby performing handover.

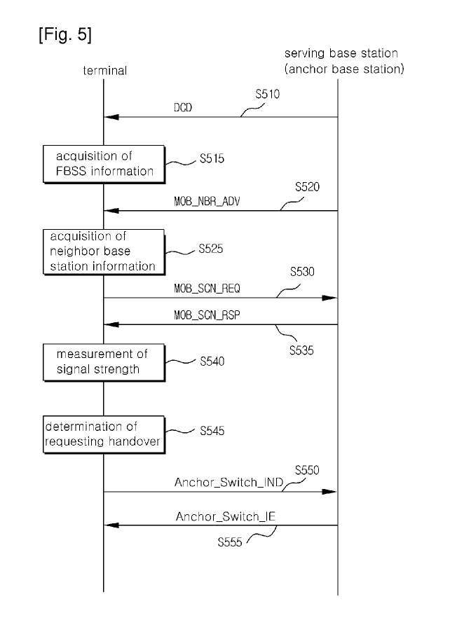

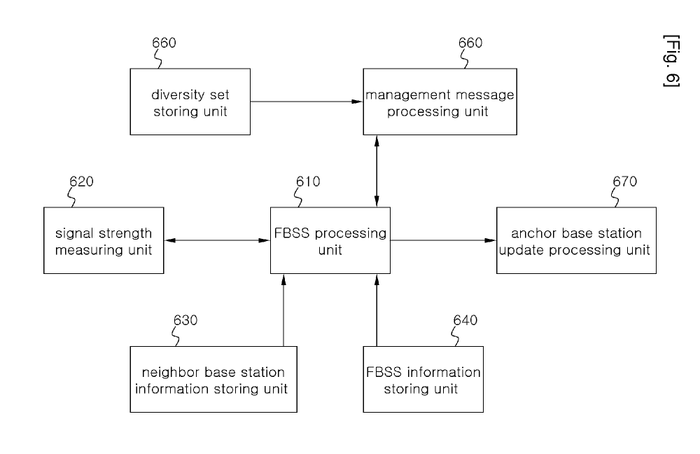

FIG. 5 is a flowchart illustrating the method of performing a handover according to a second embodiment of the present invention.

For reference, in this embodiment, the anchor base station update is performed using the fast feedback channel. Furthermore, steps S510 to S545 before the request of handover are substantially identical with steps S410 to S445 of the first embodiment, thus, it will be briefly described.

At step S510, the terminal receives a DCD message which is periodically transmitted by the serving base station (anchor base station). The DCD message includes information on ‘Anchor Switch Report (ASR) Slot Length (M) and Switching Period (L)’ and ‘trigger TLV’. Furthermore, the terminal acquires the FBSS information based on the DCD message.

Furthermore, the terminal receives the neighbor base station advertisement message (MOB_NBR_ADV) which is periodically transmitted by the serving base station at step S520. Then, the terminal acquires information on neighbor base stations based on the neighbor base station advertisement message at step S525.

Meanwhile, the terminal requests parameters required for scanning by transmitting a scanning request message (MOB_SCN_REQ) to the serving base station in order to measure quality of signals received by the neighbor base station at step S530. Thereafter, the serving station transmits a scanning response message (MOB_SCN_RSP) to the terminal at step S535.

At step S540, the terminal measures the signal quality by synchronizing with respective neighbor base stations and measuring the CINR based on the scanning response message, during a scanning period. Furthermore, at step S545, the terminal determines whether the request for handover should be performed based on the measured signal quality.

The determination of the request for handover is performed based on the condition that the signal strength of the serving base station decreases below the diversity set deletion threshold value. Furthermore, as to another condition of the present invention, the signal strength of the neighbor base station is higher than the signal strength of the serving base station by the triggering value. That is, the terminal requests the serving base station to perform the anchor base station update when the condition for requesting handover (for example, the CINR of the neighbor base station is higher than the CINR of the serving base station by the triggering value) is satisfied with reference to the ‘trigger TLV’ of the DCD message transmitted at step S510.

When the condition for requesting handover is satisfied at step S545, the terminal transmits an anchor switching indication message (Anchor_Switch_IND) to the serving base station using the fast feedback channel. The anchor switching indication message includes information on a neighbor base station (target station) for handover. A Channel Quality Indicator Channel (CQICH) assigned from a current serving base station may be used for the fast feedback channel. As described above, the terminal alternatively transmits a CQI report for the serving base station and the anchor switching indication message including the temporary ID (TEMP_BSID) of the target base station during an Anchor Switch Report (ASR) switching period (L) through the CQI channel assigned by the serving base station with reference to the Anchor Switch Report (ASR) Slot Length (M) and Switching Period (L) of the DCD message transmitted at step S510.

At step S550, the serving base station transmits a anchor switching information message (Anchor_Switch_IE) which determines the permission/cancellation of switching and the assignment of CQI to the terminal during switching period. The terminal performs handover to the target base station after the switching period has elapsed when the switching is permitted.

FIG. 6 is a diagram illustrating an apparatus for performing handover according to the present invention.

As illustrated in FIG. 6, the apparatus for performing handover according to the present invention includes a FBSS processing unit 610, a signal strength measuring unit 620, a neighbor base station information storing unit 630, a FBSS information storing unit 640, a diversity set storing unit 650, a MAC management message processing unit 660, and an anchor base station update processing unit 670.

The FBSS processing unit 610 performs an overall function for FBSS in cooperation with the signal strength measuring unit, the neighbor base station information storing unit, the FBSS information storing unit, the MAC management message processing unit, the anchor base station update processing unit. The detailed operation or function relating to it is described below.

The signal strength measuring unit 620 measures the signal strength for the serving base station and the neighbor base stations included in the diversity set in response to the request of the FBSS processing unit, and transmits the measured result to the FBSS processing unit. The measurement of signal strength is performed based on the scanning response message (MOB_SCN_RSP) transmitted from the serving base station, and the scanning response message includes information for measuring the signal strength, such as a scanning interval, an interleaving interval, an iteration, and a start frame.

The neighbor base station information storing unit 630 stores information on the neighbor base station extracted from the neighbor base station advertisement message (MOB_NBR_ADV) which is periodically transmitted from the serving base station, and, if necessary, transmits the information to the FBSS processing unit. The neighbor base station information includes the channel parameter of the neighbor base stations, which is used to generate the diversity set.

The FBSS information storing unit 640 stores information required to operate the FBSS among the TLV of the DCD message which is periodically transmitted from the serving base station, and, if necessary, transmits the information to the FBSS processing unit. The FBSS information includes the diversity set addition threshold value, the diversity set deletion threshold value, the anchor switch report slot length and switching period, and the trigger TLV.

The diversity set storing unit 650 stores the base station information (that is, the activated base station information) for FBSS generated through communication of the MAC management message with the serving base station based on the FBSS information from the FBSS information storing unit and the signal strength measured by the signal strength measuring unit.

The MAC management message processing unit 660 transmits and receives the IEEE802.16d/e based MAC management message for the base station, in cooperation with the diversity set storing unit and the FBSS processing unit. The MAC management message includes the handover request message (MOB_MSHO_REQ), the handover response message (MOB_BSHO_RSP), the handover indication message (MOB_HO_IND), which is used to add/delete the neighbor base station to/from the diversity set or to perform the anchor base station update.

The anchor base station update processing unit 670 triggers the anchor base station update under the control of the FBSS processing unit, and sets up the neighbor base station (target base station) acquired through the MAC management message or the fast feedback channel as new serving base station(anchor base station).

Hereinafter, the relation between the components of the apparatus for performing handover is described in detail.

The MAC management message processing unit receives the DCD message from the serving base station and transmits the DCD message to the FBSS processing unit. The FBSS processing unit extracts the FBSS information from the DCD message and transmits the information to the FBSS information storing unit. Furthermore, the MAC management message processing unit receives the neighbor base station advertisement message (MOB_NBR_ADV) from the serving base station and transmits the message to the FBSS processing unit. The FBSS processing unit extracts the neighbor base station information from the neighbor base station advertisement message and transmits the information to the neighbor base station information storing unit.

Meanwhile, the FBSS processing unit transmits the scanning request message (MOB_SCN_REQ) to the serving base station through the MAC management message processing unit in order to measure the signal strength of the neighbor base station. The MAC management message processing unit receives the scanning response message (MOB_SCN_RSP) from the serving base station and transmits the scanning response message to the FBSS processing unit. Then, the FBSS processing unit requests the measurement of the signal strength by transmitting the information required for scanning to the signal strength measuring unit. The signal strength measuring unit transmits the results of the measurement of the signal strength for the serving base station and the neighbor base station to the FBSS processing unit. The FBSS processing unit determines whether the handover is to be performed or not based on the FBSS information stored in the FBSS information storing unit. For example, the FBSS processing unit requests the serving base station to perform handover when the signal strength of the serving base station is lower than the diversity set deletion threshold value or the signal strength of the neighbor base station is higher than the signal strength of the serving base station by the triggering value.

In case the serving base station determines to perform handover through the anchor base station update, the FBSS processing unit requests the anchor base station update processing unit to perform the anchor base station update. Finally, the anchor base station update processing unit sets the neighbor base station as a new anchor base station through the MAC management message or the fast feedback channel to perform handover.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A method of performing handover in a wireless communication system, the method comprising the steps of:
a) receiving a Downlink Channel Descriptor (DCD) message from a serving base station and acquiring Fast Base Station Switching (FBSS) information;
b) receiving a neighbor base station advertisement message from the serving base station and acquiring a neighbor base station information;
c) measuring the signal strength of the serving base station and the neighbor base station based on the neighbor base station information;
d) transmitting a handover request message to the serving base station, when the difference between the signal strength of the neighbor base station and the signal strength of the serving base station is a predetermined triggering value; and
e) transmitting a handover indication message to the serving base station and performing a handover by triggering an anchor base station update when a handover response message is received from the serving base station in response to the handover request message.

2. The method of claim 1, wherein the triggering value is equal to or lower than the difference between a diversity set addition threshold value and a diversity set deletion threshold value.

3. The method of claim 1, wherein the step d) transmits the handover request message to the serving base station, when the signal strength of the serving base station decreases below a diversity set deletion threshold value before the difference between the signal strength of the neighbor base station and the signal strength of the serving base station is equal to the predetermined triggering value.

4. The method of claim 1, wherein the DCD message includes a trigger Type, Length and Value(TLV) information defined to trigger the anchor base station update when the signal strength of the neighbor base station is higher than the signal strength of the serving base station as much as the predetermined triggering value.

5. The method of claim 1, wherein the step c) comprises:
c1) transmitting a scanning request message to the serving base station;
c2) receiving a scanning response message from the serving base station in response to the canning request message; and
c3) measuring the signal strengths of the serving base station and the neighbor base station, based on the neighbor base station information and the scanning response message.

6. The method of claim 5, wherein the signal strength is measured by using at least one of a Carrier to Interference and Noise Ratio (CINR), a Received Signal Strength Indication (RSSI), and a Real Time Difference (RTD).

7. A method of performing handover in a wireless communication system, the method comprising the steps of:
a) receiving a Downlink Channel Descriptor (DCD) message and a neighbor base station advertisement message from a serving base station and acquiring a signal strength of the serving base station and a neighbor base station;
b) transmitting an anchor switching indication message to the serving base station through a fast feedback channel, when the signal strength of the neighbor base station is higher than the signal strength of the serving base station as much as a predetermined triggering value; and
c) performing a handover by triggering the anchor base station update when an anchor switching information message for permitting the anchor switching in response to the anchor switching indication message is received from the serving base station.

8. The method of claim 7, wherein the step b) transmits the anchor switching indication message to the serving base station, when the signal strength of the serving base station is lower than a diversity set deletion threshold value before the signal strength of the neighbor base station becomes higher than the signal strength of the serving base station as much as the predetermined triggering value and the triggering value is equal to or lower than the difference between a diversity set addition threshold value and a diversity set deletion threshold value.

9. The method of claim 7, wherein the DCD message includes a trigger Type, Length and Value (TLV) information defined to trigger the anchor base station update, when the signal strength of the neighbor base station is higher than the signal strength of the serving base station as much as the predetermined triggering value.

10. The method of claim 7, wherein the DCD message includes an Anchor Switch Report (ASR) Slot Length (M) and Switching Period (L) information, and the fast feedback channel is established based on the Anchor Switch Report (ASR) Slot Length (M) and Switching Period (L) information.

11. The method of claim 7, wherein the step a) of acquiring a signal strength of the serving base station and a neighbor base station comprises:
a1) transmitting a scanning request message to the serving base station;
a2) receiving a scanning response message from the serving base station in response to the canning response message; and
a3) measuring the signal strengths of the serving base station and the neighbor base station, based on the neighbor base station information and the scanning response message.

12. A method of performing handover in a wireless communication system, the method comprising the steps of:
a) measuring signal strengths of a serving base station and a neighbor base station; and
b) performing a handover when the signal strength of the neighbor base station is higher than the signal strength of the serving base station as much as a predetermined triggering value.

13. The method of claim 12, wherein the step b) transmits a handover indication message or an anchor switching indication message to the serving base station, when the signal strength of the serving base station is lower than a diversity set deletion threshold value before the signal strength of the neighbor base station is higher than the signal strength of the serving base station as much as the predetermined triggering value, and the triggering value is equal to or lower than the difference between a diversity set addition threshold value and a diversity set deletion threshold value.

14. The method of claim 12, wherein the step b) includes a step of triggering an anchor base station update through a MAC management message or a fast feedback channel.

15. The method of claim 12, wherein, after step a), further comprising b′) performing a diversity set update based on the signal strength of the neighbor base station.

16. The method of claim 15, wherein the diversity set update is performed by adding the neighbor base station to the diversity set when the signal strength of the neighbor base station which is not included in the diversity set is higher than a predetermined diversity set addition threshold value, and deleting the neighbor base station from the diversity set when the signal strength of the neighbor base station which is included in the diversity set is lower than a predetermined diversity set deletion threshold value.

17. An apparatus of performing handover in a wireless communication system, the apparatus comprising:
a signal strength measuring unit for measuring a signal strength for a serving base station and a neighbor base station;
a MAC management message processing unit for transmitting and receiving a MAC management message for the serving base station;
an anchor base station update processing unit for triggering an anchor base station update; and
a FBSS processing unit for requesting the anchor base station update processing unit to trigger the anchor base station update, when the signal strength of the neighbor base station is higher than the signal strength of the serving base station by a predetermined triggering value, based on a DCD message transmitted from the MAC management message processing unit.

18. The apparatus of claim 17, wherein the triggering value is lower than a difference value between a diversity set addition threshold value and a diversity set deletion threshold value.

19. The apparatus of claim 17, wherein the FBSS processing unit requests the anchor base station update processing unit to trigger the anchor base station update, when the signal strength of the serving base station is lower than a diversity set deletion threshold value before the signal strength of the neighbor base station becomes higher than the signal strength of the serving base station as much as the predetermined triggering value.

20. The apparatus of claim 17, wherein the DCD message includes a trigger Type, Length and Value (TLV) information defined to trigger the anchor base station update when the signal strength of the serving base station is lower than the signal strength of the neighbor base station as much as or beyond the predetermined triggering value.

21. The apparatus of claim 17, wherein the signal strength is measured by using at least one of CINR, RSSI, and RTD.

22. The apparatus of claim 20, wherein the DCD message includes a MAC Management Message Type (MMT) field, a Configuration Change Count (CCC) field, and a TLV field for FBSS, while the trigger TLV information is included in the TLV field.

23. The apparatus of claim 22, wherein the TLV field further includes a diversity set addition threshold value (H_Add_Threshold), a diversity set deletion threshold value (H_Delete_Threshold), and an Anchor Switch Report (ASR) Slot Length (M) and Switching Period (L) information.

24. The apparatus of claim 22, wherein the trigger TLV information includes a Type, Function and Action (TFA), a Trigger Value (TV), and a Trigger Averaging Duration (TAD).
